(19) United States
(12) Patent Application Publication
(10) Pub. No.: US 2009/0226598 A1
(43) Pub. Date: Sep. 10, 2009

(54) Substrate Coating Apparatus Having a Solvent Vapor Emitter

(75) Inventors: James Feng, Maple Grove, MN (US); Frank Genovese, Longboat Key, FL (US); James Lee Shippy, Maple Grove, MN (US)

Correspondence Address: VIDAS, ARRETT & STEINKRAUS, P.A., SUITE 400, 6640 SHADY OAK ROAD, EDEN PRAIRIE, MN, 55344, US

(73) Assignee: BOSTON SCIENTIFIC SCIMED, INC., Maple Grove, MN (US)

(21) Appl. No.: 12/363,979

(22) Filed: Feb. 2, 2009

Related U.S. Application Data
(60) Provisional application No. 61/027,504, filed on Feb. 11, 2008.

(51) Int. Cl. B05D 3/10; B05C 9/08

(52) U.S. Cl. 427/2.1; 118/58; 427/335

(57) ABSTRACT

An apparatus for depositing coating onto a substrate including a housing having a nozzle including a nozzle orifice, a fluid source configured to deliver coating fluid to the nozzle, and a solvent vapor emitter. The solvent vapor emitter can be located proximate to the nozzle, for example, such as behind the nozzle orifice and/or in a direction substantially parallel to a central axis of the housing. During coating, coating fluid may exit the nozzle and is deposited onto the substrate while the solvent vapor emitter emits solvent vapor proximate to the nozzle orifice.

### CROSS-REFERENCE TO RELATED APPLICATIONS

This application claims priority from Provisional Application No. 61/027,504, filed Feb. 11, 2008, the contents of which is hereby incorporated by reference

### TECHNICAL FIELD

The present application generally relates to an apparatus for depositing a coating on a substrate.

### BACKGROUND

The positioning and deployment of implantable medical devices within a target site of a patient are common, often repeated, procedures of contemporary medicine. These devices, which may be implantable stents, chronic rhythm management leads, neuromodulation devices, implants, grafts, defibrillators, filters, and catheters, as well as other devices, may be deployed for short or sustained periods of time and may be used for many medicinal purposes. These can include the reinforcement of recently re-enlarged lumens, the replacement of ruptured vessels, and the treatment of disease, such as vascular disease, through the delivery of therapeutic agent.

Coatings may be applied to the surfaces of implantable medical devices to transport therapeutic agent to a target site and to release it at the target site. Coatings may also be provided for other purposes, such as radiopacity or biocompatibility. Many coating methods have been proposed, including dip coating, spray coating, etc. In certain instances, it is desired to apply precise amounts of coating to specific areas of the device. For such applications, coating by fine dot/line printing technology, for example an inkjet method, has been proposed.

### BRIEF DESCRIPTION

Certain embodiments of the present invention are directed to an apparatus for depositing coating onto a substrate and can include a housing having a nozzle including a nozzle orifice, a fluid source configured to deliver coating fluid to the nozzle, and a solvent vapor emitter. The solvent vapor emitter can be located proximate to the nozzle, for example behind the nozzle orifice so that the solvent vapor emitter does not interfere with the interface between the nozzle orifice and the substrate. The solvent vapor emitter can be arranged in a direction substantially parallel to a central axis of the housing during delivery. During coating, coating fluid exits the nozzle and can be deposited onto the substrate while the solvent vapor emitter emits solvent vapor proximate to the nozzle orifice. The substrate can be a medical device. In certain embodiments, the substrate is a stent.

Other embodiments of the present invention are directed to a method for depositing coating onto a substrate and can include the steps of providing a housing having a nozzle including a nozzle orifice, delivering a coating fluid from the nozzle and onto a target surface of a substrate, and emitting solvent vapor from a solvent vapor emitter. The solvent vapor emitter can be located proximate to the nozzle, such as behind the nozzle orifice, and/or arranged in a direction substantially parallel to a central axis of the housing during delivery.

Other embodiments of the present invention are directed to a method for depositing coating onto a substrate and can include the steps of providing a housing having a nozzle including a nozzle orifice and creating a saturated-vapor environment proximate to the nozzle orifice without interfering with the ability of the nozzle to adequately apply coating to the substrate.

The invention may be embodied by numerous other devices and methods. The description provided herein, when taken in conjunction with the annexed drawings, discloses examples of the invention. Other embodiments, which incorporate some or all steps as taught herein, are also possible.

### BRIEF DESCRIPTION OF THE DRAWINGS

Referring to the drawings, which form a part of this disclosure:

FIG. 1a shows a side view of an apparatus for coating a substrate as may be employed with certain embodiments of the present invention;

FIG. 1b shows an enlarged view of an exit of the solvent vapor emitter of FIG. 1a;

FIG. 2 shows a side view of an apparatus for coating a substrate as may be employed with other embodiments of the present invention; and

FIG. 3 shows a side view of an apparatus for coating a substrate as may be employed with another embodiment of the present invention.

### DETAILED DESCRIPTION

Micro-scale site-specific control may be required when coating substrates such as medical devices, micro-electronic products, and micro-scale writing products. Many of the coating process technologies that offer micro-scale site-specific control utilize dispensing nozzles having small orifices (e.g., having diameters ranging from 20-50 microns). For instance, the diameter of Ohmcraft™ MicroPen™ dispensing nozzle orifices may be as small as approximately 25 microns, and the diameter of certain drop-on-demand inkjet dispensing nozzle orifices are generally about 35 microns.

The common challenge of using these dispensing nozzles is that their orifices can clog due to drying of the coating being dispensed because of solvent evaporation. This clogging may disrupt the production process and/or cause damage to the equipment. The susceptibility of these dispensing nozzle orifices to clog can limit these coating process technologies to using coatings having solvents of relatively low volatility (e.g., xylene and dimethylformide (DMF)). Thus, the range of solvents that can be used for these existing coating process technologies can be limited.

To address the drawbacks of existing coating process technologies, one potential approach is to place the dispensing nozzle within an isolator (e.g., a glove box). The dispensing nozzle is placed inside the isolator, and the internal chamber of the isolator is saturated with solvent vapor. A drawback of this type of coating process, however, is that it prevents in-process solvent evaporation from the coating after deposition onto the substrate. In other words, the coated substrate would not dry until after it is taken out of the isolator. In addition, another drawback of using an isolator is that safety precautions must be taken when using flammable solvents (e.g., filling the isolator with inert gases to deplete oxygen). However, in-process evaporation after deposition can be desirable and sometimes crucial in coating substrates such as medical devices. For example, in-process evaporation after deposition may be desirable for avoiding line spreading when coating stent struts or when multiple layers or stacks of coating droplets is desired. More specifically, in-process evaporation after deposition can be desirable in drop-on-demand inkjet applications, in which it may take approximately twenty-five or more drops to produce the typically desired coating thickness or coat weight to meet the drug dosage target. In certain drop-on-demand inkjet applications, drops ejected from the dispensing nozzle contain large percentages of solvent that need to evaporate before the next drop is deposited on top of it (the stacked-up drops will droop without adequate in-process evaporation after deposition).

Certain embodiments of the present invention address the drawbacks associated with existing coating process technologies to limit and/or prevent small-orifice clogging by creating a saturated-vapor environment proximate to the orifice of the dispensing nozzle, without interfering with the ability of the nozzle to adequately apply coating to the substrate. Limiting and/or preventing clogging can allow micro-scale dispensing nozzles to be used with more volatile solvents (e.g., toluene and tetrahydrofuran (THF)) than existing coating process technologies permit.

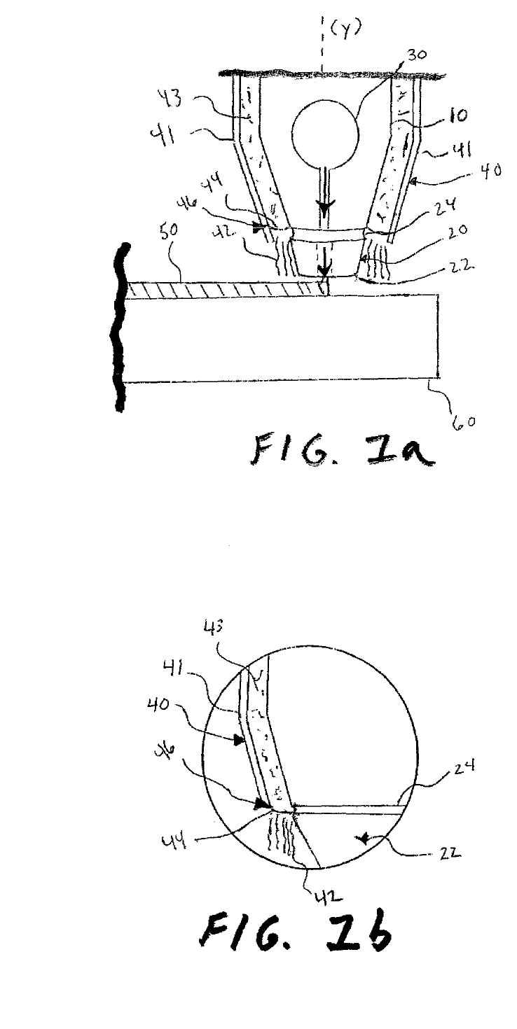

Referring initially to FIGS. 1a-b, an apparatus for coating a substrate is shown having a housing 10, a nozzle 20 including an orifice 22, a fluid source 30, a solvent vapor emitter 40, a coating 50, and a substrate 60. A fluid, for example, a therapeutic agent mixed with a solvent, can be delivered from the fluid source 30 to the nozzle 20 and out of the orifice 22 for deposition onto a target surface of substrate 60. To prevent clogging, as described in more detail below, during deposition, the solvent vapor emitter 40 emits solvent vapor 42 proximate to the orifice 22.

The housing 10 shown in the example of FIGS. 1a-b may be an Ohmcraft™ MicroPen™. The housing 10 shown is conically shaped at its end and includes a nozzle 20 having an annular orifice 22.

Any suitable shapes may be used for the nozzle 20 and orifice 22. For example, in other embodiments, the nozzle 20 and orifice 22 may be rectangular in shape. Likewise, any suitable sizes may be used for the nozzle 20 and orifice 22. For instance, in the examples shown, the orifices 22 have diameters of between about 20 and 50 microns. If a square orifice 22 were used, the width of the orifice 22 could also be between 20 and 50 microns. Other sizes may be used depending on the application.

In the example, an outer surface of the nozzle 20 includes a retaining member 24 for retaining a ring shaped meniscus 44 of solvent 43 proximate to an exit 46 of the solvent vapor emitter 40. In the example, the retaining member 24 is a groove that is cut into the outer surface of the nozzle 22. This aspect is discussed in more detail below.

Any suitable micro-dispensing device may be used as the housing 10. Examples of micro-dispensing devices include, but are not limited to, drop-on-demand coating devices (e.g., inkjet printing heads having nozzle orifices with a diameter, for example, of approximately 35 microns), spray type applicators (e.g., paint guns and spray coaters), and other micro-scale direct writing related devices (e.g., ball point and felt tip applicators having nozzle orifices with a diameter, for example, of approximately 25 microns).

As seen in FIGS. 1a-b, a fluid source 30 is shown that may provide fluid to the nozzle 20. Any suitable fluid source may be used, for example, a reservoir is suitable. Likewise, any suitable arrangements of conduits and components to pressurize or move the fluid (e.g., pumps, coolers, heaters, valves, etc.) may be used to supply the fluid to the nozzle 20 from the fluid source 30.

FIGS. 1a-b also show a solvent vapor emitter 40. The solvent vapor emitter 40 may be used for forming, such as by pinning, the ring shaped meniscus 44 of solvent 43 at its exit 46. The solvent vapor emitter 40 can be filled manually and/or may be in communication with a solvent source.

In the example, the solvent vapor emitter 40 is comprised of a sheath 41 that extends around the periphery of the nozzle 20. In other arrangements, the sheath 41 may extend around only a portion(s) of the nozzle 20. Solvent 43 may be provided between an inner surface of the sheath and the outer surface of the housing 10. The solvent vapor emitter 40 may be arranged in a direction parallel to a central axis (y) of the housing. In embodiments wherein the nozzle 20 faces downward, this orientation of the solvent vapor emitter 44 can facilitate gravitational fluid flow.

The solvent 43 may travel between the sheath 41 and nozzle 20 by a combination of capillary action and gravity to form the ring shaped meniscus 44 of solvent 43 proximate to the exit 46 of the sheath 41. In certain embodiments, the solvent source, and/or conduits between the solvent source and solvent vapor emitter 40, may include a regulator(s) (e.g., valves) to adjust back pressure (e.g., pressure formed by twist and turns of solvent vapor emitter) against capillary pressure to adjust the ring shaped meniscus 44.

As discussed above, to prevent the solvent 43 from leaking out onto nozzle 20, retaining member 24 is provided on the outer surface of the nozzle 20 to pin the ring shaped meniscus 44 of solvent 43. In the example, a groove is provided in the outer surface of the nozzle 20 to pin the ring shaped meniscus 44 of solvent 43. Although a groove is used in the example, any suitable retaining member 24 capable of retaining the meniscus may be used. For example, a retaining member 24 could be positioned over the outer surface of the nozzle 20 to form an edge.

The ring meniscus 44 of solvent 43 emits solvent vapor 42 proximate to the orifice 22. Solvent vapor 42 from the ring shaped meniscus 44 of solvent 43 can thereby create a near-saturated or saturated-vapor environment proximate to the orifice 22 of the nozzle 20 during coating. It can be appreciated that the solvent vapor concentration may diminish with distance from the meniscus 44. The meniscus 44 can be located close to the orifice 22 to provide a high concentration of solvent vapor 42 close to the orifice 22 but lower concentrations as the distance away from the orifice 22 increases.

For example, when using a device similar to a MicroPen™, the concentration of solvent vapor 42 can be negligible at a distance of greater than about 0.5 mm (e.g., 10× the nozzle size of the MicroPen™). Because the solvent vapor concentration may diminish and become negligible at a certain distance, the deposited coating outside a small region around the nozzle 20 and orifice 22 can still evaporate and dry as usual to suitably form the coating 50 on the substrate 60 as desired.

Providing the solvent vapor proximate the nozzle orifice as described thus provides a solvent vapor environment at the point where the coating fluid exits the nozzle. In this way, the evaporation of the solvent from the coating fluid is avoided or substantially reduced. Thus, because of the elimination or reduction of solvent evaporation from the fluid, the risk of clogging the nozzle is eliminated or diminished.

In the embodiment as described above, the solvent vapor emitter 40 is placed behind the nozzle orifice 22. That is, it is positioned around the nozzle at a position proximal to, as opposed to distal to, the nozzle orifice. In this way, the solvent vapor emitter 40 does not interfere with the interface between the nozzle orifice 22 and the substrate. In certain applications that require precise dispensing, the nozzle orifice 22 must be positioned very close to the substrate, e.g., within 0.5 mm or less, leaving only a small gap. Thus, it can be advantageous in these applications to have the solvent vapor emitter 40 behind the orifice 22 as shown rather than in front of the orifice 22, i.e., rather than between the orifice 22 and the substrate, where it could interfere.

In the example of FIG. 1, it can be seen that an inner surface of the solvent vapor emitter 40, and outer surfaces of the housing 10 and nozzle 20, form a space for receiving the solvent 43. In this embodiment, the entire solvent vapor emitter 40 is positioned behind the nozzle orifice 22 so as to prevent interference with the interface between the orifice 22 and the substrate.

The previously described components can be made of any suitable materials. For example, the nozzle 20 and solvent vapor emitter 40 can be made of materials with surface properties configured to prevent solvent wetting.

In the example of FIG. 1, the substrate 60 being coated is a stent; however, it will be appreciated that other medical devices and substrates can be used.

For example, with respect to medical devices, medical devices which may be coated include, but are not limited to, implantable stents, chronic rhythm management leads, neuromodulation devices, implants, grafts, defibrillators, filters, and catheters.

Further, other embodiments of the invention include using the above-described device and method to coat micro-electronic and micro-scale related products. For example, since certain embodiments of the present invention can reduce restrictions on ink drying rates and formulations, more robust inkjet technologies for printing and other micro-dispensing applications may be developed.

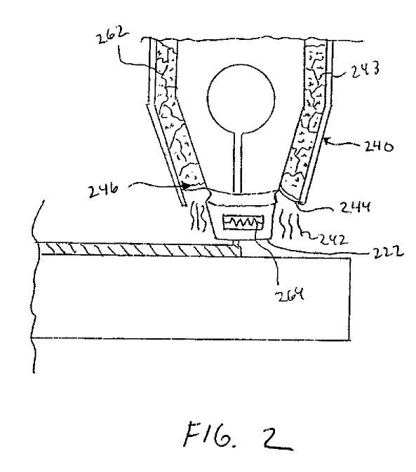

Turning to FIG. 2, in other embodiments of the present invention, a porous insert 262 may be used to assist with retaining the pure-solvent meniscus 244 at the exit 246 of the solvent vapor emitter 240. Any porous material may be used including, but not limited to, felts, sponges, and/or any material consisting of small connected pores that can be placed inside the sheath.

The porous insert 262 may be used to ensure that the solvent 243 travels through the porous insert 262 at about the same rate of evaporation of the solvent vapor 242 from the ring shaped meniscus 244 to establish the near-saturated or saturated solvent vapor environment around the orifice 222.

The nozzle and/or substrates themselves may also be subject to temperature controls. For example, as seen in FIG. 2, a thermoelectric element 264 may be positioned within and/or on the nozzle 220 to cool and/or heat the nozzle 220 as desired. Likewise, solvent temperatures and pressures may also be adjusted to produce the desired results. Cooling the nozzle may be applied in other embodiments, such as the embodiment of FIGS. 1A-1B, and can help reduce or eliminate solvent evaporation at the nozzle tip.

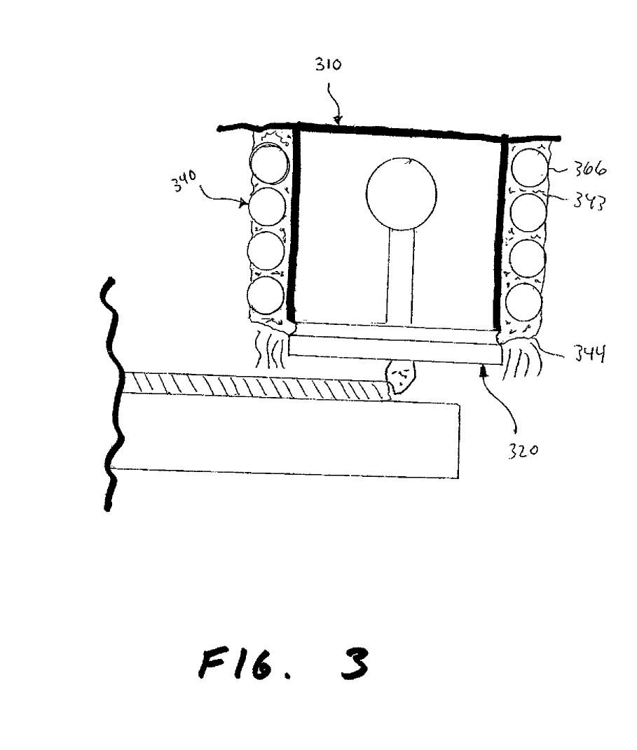

As seen in FIG. 3, in other embodiments of the present invention, the solvent vapor emitter 340 may be formed by fiber or wire 366. For example, fiber and/or wire may be wrapped around the housing 310. For example, wire 366 may be used to provide micro-channels for supplying solvent 343 to form the solvent vapor emitting ring shaped meniscus 344 proximate to the last wire coil. In this example, the wire does not include a sheath, however, it may if desired. In certain embodiments of the present invention, the wire coils contact one another, while in other embodiments of the present invention, the wire coils do not contact one another. In either case, a sheath may be utilized to limit and/or prevent solvent evaporation from surfaces other than in the vicinity of the nozzle orifice. Still other arrangements are possible.

As is also seen in this example, the housing 310 being utilized is a drop-on-demand type housing. The drop-on-demand housing is comprised of a housing 310 and a nozzle 320 in communication with a fluid source.

Inkjet technologies can be used to create droplets of fluid that are ejected against target surfaces of substrates. For example, thermal, piezoelectric, and continuous inkjet technologies, as are known in the art, may used to create and eject the droplets of the fluid at a substrate.

Thermal based technologies relate to using a pulse of current through heating elements causing a bubble to form and expand in a fluid chamber to eject a droplet of fluid onto a substrate. Piezoelectric technologies relate to using an ink-filled chamber behind the nozzle. When a voltage pulse is applied a pressure pulse is generated in the fluid forcing a droplet of fluid out of the nozzle orifice. In continuous technologies, a high pressure pump directs fluid from a reservoir through a nozzle to create a continuous stream of fluid droplets. A piezoelectric crystal creates an acoustic wave as it vibrates within the nozzle to cause the liquid to break into droplets at regular intervals for placement on a substrate.

While various embodiments have been described, other embodiments are possible. It should be understood that the foregoing descriptions of various examples of the apparatus including a solvent vapor emitter are not intended to be limiting, and any number of modifications, combinations, and alternatives of the examples may be employed to facilitate the coating of substrates.

The term “therapeutic agent” as used herein includes one or more “therapeutic agents” or “drugs.” The terms “therapeutic agents” or “drugs” can be used interchangeably herein and include pharmaceutically active compounds, nucleic acids with and without carrier vectors such as lipids, compacting agents (such as histones), viruses (such as adenovirus, adenoassociated virus, retrovirus, lentivirus and α-virus), polymers, hyaluronic acid, proteins, cells and the like, with or without targeting sequences.

Specific examples of therapeutic agents used in conjunction with the present application include, for example, pharmaceutically active compounds, proteins, cells, oligonucleotides, ribozymes, anti-sense oligonucleotides, DNA compacting agents, gene/vector systems (i.e., any vehicle that allows for the uptake and expression of nucleic acids), nucleic acids (including, for example, recombinant nucleic acids; naked DNA, cDNA, RNA; genomic DNA, cDNA, RNA in non-infectious vector or in a viral vector and which further may have attached peptide targeting sequences; antisense nucleic acid (RNA or DNA); and DNA chimeras which include gene sequences and encoding for ferry proteins such as membrane translocating sequences (“MTS”) and herpes simplex virus-1 (“VP22”)), and viral liposomes and cationic and anionic polymers and neutral polymers that are selected from a number of types depending on the desired application. Non-limiting examples of virus vectors or vectors derived from viral sources include adenoviral vectors, herpes simplex vectors, papilloma vectors, adeno-associated vectors, retroviral vectors, and the like. Non-limiting examples of biologically active solutes include anti-thrombogenic agents such as heparin, heparin derivatives, urokinase, and PPACK (dextrophenylalanine proline arginine chloromethylketone); antioxidants such as probucol and retinoic acid; angiogenic and anti-angiogenic agents and factors; anti-proliferative agents such as enoxaprin, everolimus, zotarolimus, angiopeptin, rapamycin, angiopeptin, monoclonal antibodies capable of blocking smooth muscle cell proliferation, hirudin, and acetylsalicylic acid; anti-inflammatory agents such as dexamethasone, prednisolone, corticosterone, budesonide, estrogen, sulfasalazine, acetyl salicylic acid, and mesalamine; calcium entry blockers such as verapamil, diltiazem and nifedipine; antineoplastic/antiproliferative/anti-mitotic agents such as paclitaxel, 5-fluorouracil, methotrexate, doxorubicin, daunorubicin, cyclosporine, cisplatin, vinblastine, vincristine, epothilones, endostatin, angiostatin and thymidine kinase inhibitors; antimicrobials such as triclosan, cephalosporins, aminoglycosides, and nitrofurantoin; anesthetic agents such as lidocaine, bupivacaine, and ropivacaine; nitric oxide (NO) donors such as linsidomine, molsidomine, L-arginine, NO-protein adducts, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, Warfarin sodium, Dicumarol, aspirin, prostaglandin inhibitors, platelet inhibitors and tick antiplatelet factors; vascular cell growth promoters such as growth factors, growth factor receptor antagonists, transcriptional activators, and translational promoters; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and cytotoxin; cholesterol-lowering agents; vasodilating agents; agents which interfere with endogenous vascoactive mechanisms; survival genes which protect against cell death, such as anti-apoptotic Bcl-2 family factors and Akt kinase; and combinations thereof Cells can be of human origin (autologous or allogenic) or from an animal source (xenogeneic), genetically engineered if desired to deliver proteins of interest at the insertion site. Any modifications are routinely made by one skilled the art.

Polynucleotide sequences useful in practice of the application include DNA or RNA sequences having a therapeutic effect after being taken up by a cell. Examples of therapeutic polynucleotides include anti-sense DNA and RNA; DNA coding for an anti-sense RNA; or DNA coding for tRNA or rRNA to replace defective or deficient endogenous molecules. The polynucleotides can also code for therapeutic proteins or polypeptides. A polypeptide is understood to be any translation product of a polynucleotide regardless of size, and whether glycosylated or not. Therapeutic proteins and polypeptides include as a primary example, those proteins or polypeptides that can compensate for defective or deficient species in an animal, or those that act through toxic effects to limit or remove harmful cells from the body. In addition, the polypeptides or proteins that can be injected, or whose DNA can be incorporated, include without limitation, angiogenic factors and other molecules competent to induce angiogenesis, including acidic and basic fibroblast growth factors, vascular endothelial growth factor, hif-1, epidermal growth factor, transforming growth factor α and β, platelet-derived endothelial growth factor, platelet-derived growth factor, tumor necrosis factor α, hepatocyte growth factor and insulin like growth factor; growth factors; cell cycle inhibitors including CDK inhibitors; anti-restenosis agents, including p15, p16, p18, p19, p21, p27, p53, p57, Rb, nFkB and E2F decoys, thymidine kinase (“TK”) and combinations thereof and other agents useful for interfering with cell proliferation, including agents for treating malignancies; and combinations thereof. Still other useful factors, which can be provided as polypeptides or as DNA encoding these polypeptides, include monocyte chemoattractant protein (“MCP-1”), and the family of bone morphogenic proteins (“BMPs”). The known proteins include BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15, and BMP-16. Currently preferred BMPs are only of BMP-2, BMP-3, BMP-4, BMP-5, BMP-6, and BMP-7. These dimeric proteins can be provided as homodimers, heterodimers, or combinations thereof, alone or together with other molecules. Alternatively or, in addition, molecules capable of inducing an upstream or downstream effect of a BMP can be provided. Such molecules include any of the “hedgehog” proteins, or the DNAs encodings them.

The examples described herein are merely illustrative, as numerous other embodiments may be implemented without departing from the spirit and scope of the exemplary embodiments of the present application. Moreover, while certain features of the application may be shown on only certain embodiments or configurations, these features may be exchanged, added, and removed from and between the various embodiments or configurations while remaining within the scope of the application. Likewise, methods described and disclosed may also be performed in various sequences, with some or all of the disclosed steps being performed in a different order than described while still remaining within the spirit and scope of the present application.

What is claimed:

1. An apparatus for depositing coating onto a substrate, comprising:
a housing having a nozzle including a nozzle orifice;
a fluid source configured to deliver coating fluid to the nozzle, and a solvent vapor emitter located proximate to the nozzle orifice,
wherein during coating the coating fluid exits the nozzle and is deposited onto the substrate while the solvent vapor emitter emits solvent vapor proximate to the nozzle orifice.

2. The apparatus of claim 1 wherein the solvent vapor emitter is located behind the nozzle orifice.

3. The apparatus of claim 1 wherein the solvent vapor emitter is oriented in a direction substantially parallel to a central axis of the housing.

4. The apparatus of claim 1 wherein the housing is selected from the group consisting of a micro-dispenser and a drop-on-demand device.

5. The apparatus of claim 1 wherein the housing is selected from the group consisting of spray applicators, micro-electronic products, and micro-scale writing products.

6. The apparatus of claim 1 wherein the nozzle orifice has a diameter of about between 20-50 microns.

7. The apparatus of claim 1 wherein the housing is a drop-on-demand device and the nozzle orifice has a diameter of approximately 35 microns.

8. The apparatus of claim 1 wherein the housing is a micro-dispenser and the nozzle orifice has a diameter of approximately 25 microns.

9. The apparatus of claim 1 wherein the solvent vapor emitter is comprised of a sheath and the solvent is stored between an inner surface of the sheath and an outer surface of the housing.

10. The apparatus of claim 1 wherein the solvent is a volatile solvent selected from the group consisting of toluene and THF.

11. The apparatus of claim 1 wherein the solvent vapor emitter is comprised of a sheath that extends around at least a portion of an outer surface of the nozzle.

12. The apparatus of claim 1 wherein the nozzle includes a retaining member for pinning a meniscus of solvent proximate to an exit of the solvent vapor emitter.

13. The apparatus of claim 1 wherein the apparatus includes a temperature control element for varying the temperature of the nozzle.

14. The apparatus of claim 1, wherein the coating fluid comprises a therapeutic agent.

15. The apparatus of claim 1, wherein the substrate is a medical device selected from the group consisting of implantable stents, chronic rhythm management leads, neuromodulation devices, implants, grafts, defibrillators, filters, and catheters.

16. The apparatus of claim 1 wherein the solvent vapor emitter includes a porous insert.

17. An apparatus for depositing coating onto a substrate, comprising:
a nozzle including a nozzle orifice and a retaining member;
a fluid source configured to deliver coating fluid to the nozzle, and
a solvent vapor emitter located proximate to the nozzle orifice, said solvent vapor emitter comprising a sheath extending substantially around the nozzle, the sheath and retaining member retaining a solvent meniscus.
wherein during coating the coating fluid exits the nozzle and is deposited onto the substrate while the solvent meniscus emits solvent vapor proximate to the nozzle orifice.

18. The apparatus of claim 17 wherein the solvent vapor emitter is located behind the nozzle orifice.

19. A method for coating a substrate, comprising the steps of:
providing a housing having a nozzle including a nozzle orifice;
delivering a coating fluid from the nozzle to deposit the fluid onto a target surface of a substrate; and
emitting solvent vapor proximate to the nozzle orifice from a meniscus of solvent located in between an inner surface of a solvent vapor emitter and an outer surface of the housing during delivery.

20. The method of claim 19, further comprising varying the temperature of the nozzle with a temperature control element.

21. The method of claim 19, wherein the substrate is a medical device.

22. A method for coating a substrate, comprising the steps of:
providing a housing having a nozzle including a nozzle orifice; and
creating a saturated-vapor environment proximate to the nozzle orifice without interfering with the ability of the nozzle to adequately apply coating to the substrate.
